(19) United States
(12) Patent Application Publication
(10) Pub. No.: US 2024/0119342 A1
(43) Pub. Date: Apr. 11, 2024

(54) GENERAL REINFORCEMENT LEARNING FRAMEWORK FOR PROCESS MONITORING AND ANOMALY/ FAULT DETECTION

(71) Applicant: FISHER-ROSEMOUNT SYSTEMS, INC., Round Rock, TX (US)

(72) Inventors: Mark J. Nixon, Thorndale, TX (US); Shu Xu, Austin, TX (US)

(21) Appl. No.: 17/954,307

(22) Filed: Sep. 27, 2022

(51) Int. Cl. G06N 20/00

(52) U.S. Cl. CPC G06N 20/00

(57) ABSTRACT

A method includes receiving a metric-reward mapping; and using reinforcement machine learning to train a state-action mapping. A method includes receiving a set of metrics corresponding to an ongoing industrial control process; determining anomaly/fault and normal action values by reference to a reinforcement learning-determined state-action mapping; and causing a remedial action to occur. A process control system includes an anomaly/fault detection device, that receives metrics, determines anomaly/fault and normal action values; and causes a remedial action to occur.

### TECHNICAL FIELD

The present disclosure relates generally to process plants and process control systems, and more particularly, to the use of reinforcement learning and/or other machine learning techniques to achieve better anomaly/fault detection and/or other benefits within a process control system.

### BACKGROUND

Distributed process control systems, like those used in chemical, petroleum, industrial or other process plants to manufacture, refine, transform, generate, or produce physical materials or products, typically include one or more process controllers communicatively coupled to one or more field devices via analog, digital, or combined analog/digital buses, or via a wireless communication link or network. The field devices, which may be, for example, valves, valve positioners, switches, transmitters, sensors, etc., are located within the process control environment and generally perform physical or process control functions such as opening or closing valves, measuring process and/or environmental parameters (e.g., temperature or pressure), etc., to control one or more processes executing within the process plant or system. Smart field devices, such as field devices conforming to the well-known Fieldbus protocol, may also perform control calculations, alarming functions, and/or other control functions commonly implemented within the controller.

The process controllers, which are also typically located within the plant environment, receive signals indicative of process measurements made by the field devices, and/or other information pertaining to the field devices, and execute a controller application that runs, for example, different control modules. The control modules make process control decisions, generate control signals based on the received information, and coordinate with the control modules or blocks being performed in the field devices, such as HART®, WirelessHART®, or Foundation® Fieldbus field devices. The control modules implemented in the controller send the control signals over communication lines or links to the field devices to thereby control the operation of at least a portion of the process plant or system, e.g., to control at least a portion of one or more industrial processes running or executing within the plant or system. I/O devices, which are also typically located within the plant environment, typically are disposed between a controller and one or more field devices to enable communications, e.g., by converting electrical signals into digital values and vice versa.

Information from the field devices and the controller is usually made available over a communication network to one or more other hardware devices, such as operator workstations, personal computers or computing devices, data historians, report generators, centralized databases, or other centralized administrative computing devices that are typically placed in control rooms or other locations away from the harsher field environment of the plant. These hardware devices run applications that may, for example, enable an operator to perform functions with respect to controlling a process and/or operating and monitoring the process plant (e.g., changing settings of the process control routine, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc.). The communication network utilized by the hardware devices, controllers, and field devices may include a wired communication path, a wireless communication path, or a combination of wired and wireless communication paths.

As an example, the DeltaV™ control system, sold by Emerson Automation Solutions, includes multiple applications stored within and executed by different devices located at diverse places within a process plant. A configuration application, which resides in one or more workstations or computing devices in a back-end environment of a process control system or plant, enables users to create or change process control modules and download these process control modules via a communication network to dedicated distributed controllers. Typically, these control modules are made up of communicatively interconnected function blocks, which are objects in an object oriented programming protocol that perform functions within the control scheme based on inputs thereto and that provide outputs to other function blocks within the control scheme. The configuration application may also allow a configuration designer to create or change operator interfaces which are used by a viewing application to display data to an operator and to enable the operator to change settings, such as set points, within the process control routines. Each dedicated controller and, in some cases, one or more field devices, stores and executes a respective controller application that runs the control modules assigned and downloaded thereto in order to implement actual process control functionality. The viewing applications, which may be executed on one or more operator workstations (or on one or more remote computing devices in communicative connection with the operator workstations and the communication network), receive data from the controller application via the communication network and display this data to process control system designers, operators, or other users using the user interfaces, and may provide any of a number of different views, such as an operator's view, an engineer's view, a technician's view, etc. A data historian application typically stores the current process control routine configuration and data associated therewith.

The process control systems used within process control plants generate, process and store massive amounts of data, due in part to the number of devices (e.g., one thousand or more) included in the typical plant installation, most of which are streaming data continuously. This flood of data is only compounded by the recent trend toward installing connected process control devices (e.g., wireless-enabled field devices and other devices) upon initial installation or via retrofitting.

Conventionally, process control systems may process the massive amount of data generated by process plants for many purposes, including for fault detection and/or anomaly detection. Processing this data in an attempt to identify anomalous or fault conditions in the process plant may enable the plant operator to preemptively avoid costly, and potentially catastrophic, consequences. For example, the DeltaV™ control system may include a continuous data analytics mode that detects process faults resulting from changes in process variables or disturbances, or actuator or sensor problems.

As discussed in “Hierarchically Distributed Monitoring or the Early Production of Gas Flare Events,” Ind. Eng. Chem. Res. 2019, 58, 11352-11363 (hereby incorporated herein by reference in its entirety for all purposes), one use of such a system is to determine a necessary time to perform gas flaring. Gas flaring is an undesirable and, unfortunately, routine process that involves the controlled burning of waste gas. In some cases, gas flaring may be performed in a process plant to avoid overpressure events that might otherwise lead to damage or injury. Because gas flaring includes undesirable environmental, economic and regulatory consequences, process plant operators seek to avoid gas flaring whenever possible. However, as discussed in this paper, monitoring strategies for providing early warning of a potential flare event are lacking.

Conventionally, a soft sensor model (e.g., principal component analysis (PCA)) may be used to assist process engineers in anomaly/fault detection. In such cases, a pre-defined threshold based on a statistical calculation (e.g., a T2/Q limit) must be provided, so that the control system can attempt to determine a fault or anomaly. However, a single statistical constant threshold that is not based on historical knowledge of a given process may not be reliable. For example, such a constant may fail to distinguish process state changes from actual faults/anomalies. Further, PCA is not ideal especially when there are process state changes, or other situations, such as flow disturbance or state shift. A single threshold is not sufficient. Furthermore, it is widely understood that PCA-based threshold anomaly/fault detection is plagued by false positives and thus, alarm/decision fatigue by operators.

### SUMMARY

Techniques, systems, apparatuses, components, devices, and methods are disclosed for increasing the accuracy of anomaly/fault detection in process control systems, even in the presence of changing plant conditions and potentially across different plant types. Said techniques, systems, apparatuses, components, devices, and methods may apply to industrial process control systems, environments, and/or plants (interchangeably referred to herein as “industrial control,” “process control,” or “process” systems, environments, and/or “plants”), and can facilitate the development, modification, troubleshooting, stability, safety and/or other aspects of such systems. Generally, such systems and plants control, in a distributed manner, one or more processes that operate to manufacture, refine, transform, generate, or produce physical materials or products.

In one aspect of this disclosure, the process control system includes a reinforcement learning model training aspect that receives a metric-reward mapping including one or more metrics, each corresponding to a respective reward. This mapping specifies a negative reward (i.e., penalty) to be associated with each metric, such that the reinforcement learning model learns to associate certain metrics (and combinations of metrics, referred to herein as states) as being associated with either a normal action state or an anomalous/fault state. During training, this reinforcement learning model may reside in a server that is remote from the process control system/plant, and/or in a device of the process control system/plant, such as a field device. Specifically, the training aspect may include processing historical plant data (e.g., a time series of plant data corresponding to plant operation) using reinforcement learning techniques to train a state-action mapping. This mapping may be a table or a trained machine learning model (e.g., an artificial neural network) in some aspects.

At each time step, the reinforcement learning model may compute a net reward (i.e., a reward of a particular state, or sum of individual rewards associated with a plurality of rewards) by cross-referencing the metric-reward mapping. The reinforcement learning model may then update dynamic values of the state-action mapping. For example, the reinforcement learning model may update the Q-table for each unique combination of states, such that the Q-table includes a normal action value and an anomalous/fault action value for each state. The Q-table may be updated over time using live plant data, such that the Q-table action values are dynamically updated, such that the anomaly/fault detection aspects of the invention continue to learn over time. In some aspects, instead of updating Q-table values, the machine learning model may update the weights of an artificial neural network (e.g., a recurrent neural network).

Once the action-value mapping is trained, time series plant data including each of the metrics may be fed into the reinforcement learning model, and the machine learning model may determine which unique state the live plant corresponds to, and then determine whether the plant is in a normal or anomalous/fault condition at that time step. The metrics may include suitable plant operational characteristics, such as (i) a pre-defined statistical threshold, (ii) a pre-defined constant control limit, (iii) a set point indicator, (iv) a load disturbance indicator, (v) an operating stage shift indicator; or (vi) a flaring event indicator.

The time series plant data may be received from plant devices such as a sensor, a valve, a transmitter, a positioner, a standard 4-20 mA device, a field device, a HART® device, a Foundation® Fieldbus device, a Profibus device, a DeviceNet device, a ControlNet device; or a Modbus device.

When the reinforcement learning model determines that the plant is in an anomalous/fault state, the present techniques may include taking a passive or active remedial action. In general, the dynamic behavior of the present techniques represents a significant improvement over conventional systems, that do not learn over time, and thus, generate excessive false positives.

In one aspect, a computer-implemented method for improving anomaly/fault detection and/or mitigation in a process control plant includes (i) receiving a metric-reward mapping including one or more metrics, each corresponding to a respective reward; and (ii) processing an historical plant data time series using reinforcement machine learning to train a state-action mapping, wherein the processing includes computing, for at least one time step in the historical plant data time series, a net reward corresponding to the time step by cross-referencing one or more metrics in the at least one time step with the metric-reward mapping.

In another aspect, a computer-implemented method for improving plant safety and environmental impact anomaly/fault includes (i) receiving a set of metrics corresponding to an ongoing industrial control process; (ii) determining, by cross-referencing the set of metrics with reinforcement-learned information, an anomaly/fault action value and a normal action value corresponding to the set of metrics; and (iii) causing, based on the anomaly/fault action value, a remedial action to occur.

In another aspect, a process control system includes a plurality of process data generation devices, including one or more field devices configured to generate data corresponding to an ongoing industrial control process implemented by the process control system; and an electronic network that communicatively couples at least some of the plurality of physical devices to an anomaly/fault detection device, wherein the anomaly/fault detection device includes a memory having stored thereon computer-executable instructions that, when executed by one or more processors of the anomaly/fault detection device, cause the anomaly/fault detection device to: (i) receive a set of metrics corresponding to the ongoing industrial control process; (ii) determine, by cross-referencing the set of metrics with reinforcement-learned information, an anomaly/fault action value and a normal action value corresponding to the set of metrics; and (iii) cause, based on the anomaly/fault action value, a remedial action to occur.

In another aspect, one or more data generation devices configured to: (i) receive reinforcement-learned information; (ii) generate data corresponding to an ongoing industrial control process of a process control system; and (ii) process the generated data using the received reinforcement-learned information.

### BRIEF DESCRIPTION OF THE DRAWINGS

FIG. 1 depicts a block diagram of an exemplary process plant or process control system, according to some aspects.

FIG. 2 depicts a block diagram of an exemplary process plant anomaly/fault detection computing environment, according to some aspects.

FIG. 3 depicts an example an exemplary anomaly/fault detection reinforcement learning pipeline, according to some aspects.

FIG. 4 depicts a flow diagram representing an exemplary method for improving anomaly/fault detection and/or mitigation in a process control plant by using reinforcement learning to avoid false alarms, according to some aspects.

FIG. 5 depicts a flow diagram representing an exemplary method for improving plant safety and environmental impact by processing reinforcement-learned information to determine a plant anomaly/fault, according to some aspects.

### DETAILED DESCRIPTION

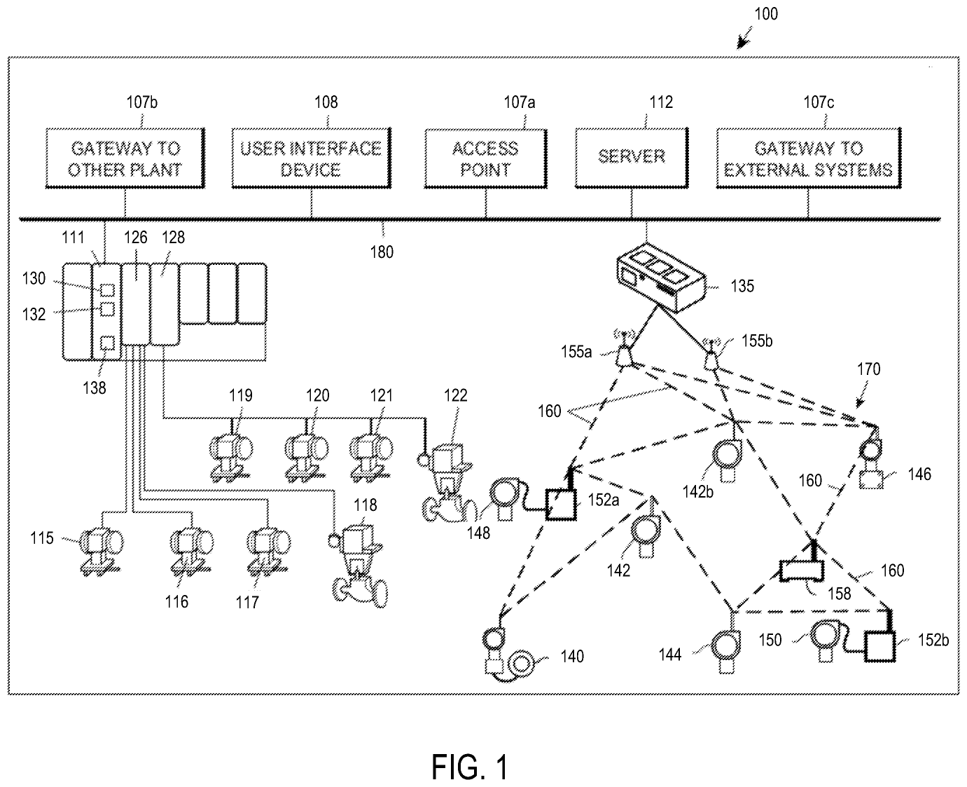

FIG. 1 depicts a block diagram of an example process control system 100 that may utilize any one or more of the novel techniques described herein. Generally, the process control system 100 processes signals indicative of process measurements made by field devices to implement a control routine, and to generate control signals that are sent over wired or wireless process control communication links or networks to other field devices to control the operation of a physical process in the process control system 100. Typically, at least one field device performs a physical function (e.g., opening or closing a valve, increasing or decreasing a temperature, taking a measurement, sensing a condition, etc.) to control the physical process. Some types of field devices communicate with other devices (e.g., controllers) using I/O devices.

In the example of FIG. 1, a process controller 111 is communicatively connected to wired field devices 115-122 via input/output (I/O) cards 126 and 128, and is communicatively connected to wireless field devices 140-146 via a wireless gateway 135 and a communication network 180.

The communication network 180 may include one or more wired and/or wireless communication links, and may be implemented using any desired or suitable or communication protocol or protocols, such as, for example, an Ethernet protocol. In some configurations (not shown) that include the controller 111, the controller 111 may be communicatively connected to the wireless gateway 135 using one or more communications networks other than the network 180, such as by using any number of other wired or wireless communication links that support one or more communication protocols, e.g., a Wi-Fi or other IEEE 802.11 compliant wireless local area network (WLAN) protocol, a mobile communication protocol (e.g., WiMAX, LTE, or other ITU-R compatible protocol), Bluetooth®, HART®, WirelessHART®, Profibus, Foundation® Fieldbus, etc.

One or more devices of the process control system 100 (possibly including the controller 111) host control system services to implement a batch process or a continuous process (e.g., using at least some of the field devices 115-122 and 140-146). In an aspect, in addition to being communicatively connected to the network 180, the controller 111 is also communicatively connected to at least some of the field devices 115-122 and 140-146 using any desired hardware and software associated with, for example, standard 4-20 mA devices, I/O cards 126, 128, and/or any smart communication protocol such as the Foundation® Fieldbus protocol, the HART® protocol, the WirelessHART® protocol, etc. In the example of FIG. 1, the controller 111, the field devices 115-122, and the I/O cards 126, 128 are wired devices, and the field devices 140-146 are wireless field devices. Of course, the wired field devices 115-122 and wireless field devices 140-146 could conform to any other desired standard(s) or protocols, such as any wired or wireless protocols, including any standards or protocols developed in the future.

The process controller 111 in the example of FIG. 1 includes a processor 130 and a memory 132. The processor 130 is configured to communicate with the field devices 115-122 and 140-146 and with other nodes communicatively connected to the controller 111. The memory 132 (e.g., random access memory (RAM) and/or read only memory (ROM)) may store computing vessels (e.g., containers) that are executed by the processor 130 to provide certain control system services. While not shown in FIG. 1, any one or more of the other devices shown in FIG. 1 (e.g., field devices 115-122 or 140-146, wireless gateway 135, or any of devices 117a, 117b, 117c, 118 or 112 discussed below) may also include memory and processors that enable those devices to similarly host one or more control system services.

In some aspects, the process control system 100 (i.e., controller 111 and/or other devices) implements a control strategy using what are commonly referred to as function blocks, where each function block operates in conjunction with other function blocks (via communications called links) to implement process control loops within the process control system 100. Control-based function blocks typically perform one of an input function (e.g., associated with a transmitter, a sensor, or some other process parameter measurement device), a control function (e.g., associated with a control routine that performs PID, fuzzy logic, etc. control), or an output function that controls the operation of some device (e.g., a valve or pump) to perform some physical function within the process control system 100. Of course, hybrid and other types of function blocks exist. Function blocks may be stored in and executed by the controller 111 (which is typically the case when these function blocks are used for, or are associated with standard 4-20 mA devices and some types of smart field devices such as HART® devices), stored in and implemented by the field devices themselves (which can be the case with Foundation® Fieldbus devices), and/or stored in an implemented by other devices of the process control system 100.

The wired field devices 115-122 may be any types of devices, such as sensors, valves, transmitters, positioners, etc., while the I/O cards 126 and 128 may be any types of I/O devices conforming to any desired communication or controller protocol. In FIG. 1, the field devices 115-118 are standard 4-20 mA devices or HART® devices that communicate over analog lines or combined analog and digital lines to the I/O card 126, while the field devices 119-122 are smart devices, such as Foundation® Fieldbus field devices, that communicate over a digital bus to the I/O card 128 using a Foundation® Fieldbus communications protocol. In some aspects, though, at least some of the wired field devices 115, 116 and 118-121 and/or at least one of the I/O cards 126, 128 additionally or alternatively communicate with the controller 111 using the network 180 and/or other suitable control system networks and protocols (e.g., Profibus, DeviceNet, Foundation® Fieldbus, ControlNet, Modbus, HART®, etc.).

In FIG. 1, the wireless field devices 140-146 communicate via a wireless process control communication network 170 using a wireless protocol, such as the WirelessHART® protocol. Such wireless field devices 140-146 may directly communicate with one or more other devices or nodes of the wireless network 170 that are also configured to communicate wirelessly (using the wireless protocol or another wireless protocol, for example). To communicate with one or more other nodes that are not configured to communicate wirelessly, the wireless field devices 140-146 may utilize the wireless gateway 135, which is connected to the network 180 or to another process control communications network. The wireless gateway 135 provides access to various wireless devices 40-58 of the wireless communications network 170. In particular, the wireless gateway 135 provides communicative coupling between the wireless devices 40-58, the wired devices 15-28, and/or other nodes or devices of the process control system 100. For example, the wireless gateway 135 may provide communicative coupling by using the network 180 and/or one or more other communications networks of the process control system 100.

Similar to the wired field devices 115-222, the wireless field devices 140-146 of the wireless network 170 perform physical control functions within the process control system 100, e.g., opening or closing valves, or taking measurements of process parameters. The wireless field devices 40-46, however, are configured to communicate using the wireless protocol of the network 170. As such, the wireless field devices 40-46, the wireless gateway 135, and other wireless nodes 52-58 of the wireless network 170 are producers and consumers of wireless communication packets.

In some configurations of the process control system 100, the wireless network 170 also includes non-wireless devices. For example, in FIG. 1, a field device 148 of FIG. 1 is a legacy 4-20 mA device and a field device 150 is a wired HART® device. To communicate within the network 170, the field devices 148 and 150 are connected to the wireless communications network 170 via a wireless adaptor 152A, 1528. The wireless adaptors 152A, 1528 support a wireless protocol, such as WirelessHART®, and may also support one or more other communication protocols such as Foundation® Fieldbus, Profibus, DeviceNet, etc. Additionally, in some configurations, the wireless network 170 includes one or more network access points 155A, 155B, which may be separate physical devices in wired communication with the wireless gateway 135, or may be provided with the wireless gateway 135 as an integral device. The wireless network 170 may also include one or more routers 158 to forward packets from one wireless device to another wireless device within the wireless communications network 170. In FIG. 1, the wireless devices 140-146 and 152-158 communicate with each other and with the wireless gateway 135 over wireless links 160 of the wireless communications network 170, and/or via the network 180.

In FIG. 1, the process control system 100 includes one or more operator workstations or user interface devices 118 that are communicatively connected to the network 180. Via the operator workstations 118, operators may view and monitor runtime operations of the process control system 100, as well as take any diagnostic, corrective, maintenance, and/or other actions that may be required. At least some of the operator workstations 118 may be located at various, protected areas in or near the process control system 100, and in some situations, at least some of the operator workstations 118 may be remotely located, but nonetheless in communicative connection with the process control system 100. Operator workstations 118 may be wired or wireless computing devices.

In some configurations, the process control system 100 includes one or more other wireless access points 117a that communicate with other devices using other wireless protocols, such as Wi-Fi or other IEEE 802.11 compliant WLAN protocols, mobile communication protocols such as WiMAX (Worldwide Interoperability for Microwave Access), LTE (Long Term Evolution) or other ITU-R (International Telecommunication Union Radiocommunication Sector) compatible protocols, short-wavelength radio communications such as near-field communications (NFC) and Bluetooth® protocols, or other suitable wireless communication protocols. Typically, the wireless access point(s) 117a allow handheld or other portable computing devices to communicate over a respective wireless process control communication network that is different from the wireless network 170 and supports a different wireless protocol than the wireless network 170. For example, a wireless or portable user interface device 8 may be a mobile workstation or diagnostic test equipment that is utilized by an operator within the process control system 100. In some scenarios, in addition to portable computing devices, one or more process control devices (e.g., controller 111, one or more of field devices 115-122, and/or one or more of wireless devices 135, 140-158) also communicate using the wireless protocol supported by the access point(s) 117a.

In some configurations, the process control system 100 includes one or more gateways 117b, 117c to systems that are external to the process control system 100 (also referred to herein as “edge gateways”). Typically, such systems are associated with customers or suppliers of information generated or operated on by the process control system 100. For example, the process control system 100 may include a gateway node 117b to communicatively connect a process plant containing the process control system 100 with another process plant. Additionally or alternatively, the process control system 100 may include a gateway node 117c to communicatively connect the process control system 100 with an external public or private system, such as another provider's process control system, a laboratory system (e.g., Laboratory Information Management System or LIMS), an operator rounds database, a materials handling system, a maintenance management system, a product inventory control system, a production scheduling system, a weather data system, a shipping and handling system, a packaging system, the Internet, and/or other external systems.

It is noted that although FIG. 1 illustrates a specific arrangement of a specific number of devices (of specific types), this is only an illustrative and non-limiting aspect. For example, the process control system 100 may omit the controller 111 as noted above, or may include multiple controllers similar to controller 111. As another example, the process control system 100 may include any number of wired and/or wireless field devices similar to field devices 115-22 and/or 140-150, any number of other devices (e.g., devices 117a, 117b, 117c, 118, 112, 152a, 152b, 155a, 155b, etc.), and so on.

Further, it is noted that the process control system 100 of FIG. 1 may include a field environment (e.g., “the process plant floor”) and a back-end environment (e.g., including server 112) which are communicatively connected by the communication network 180. As shown in FIG. 1, the field environment includes physical components (e.g., process control devices, networks, network elements, etc.) that are disposed, installed, and interconnected therein to operate to control the process during runtime. For example, the controller 111, the I/O cards 126, 128, the field devices 115-122, and other devices and network components 135, 140-150, 152, 155, 158 and 170 are located, disposed, or otherwise included in the field environment of a plant containing the process control system 100. Generally speaking, in the field environment of the process control system 100, raw materials may be received and processed using the physical components disposed therein to generate one or more products.

The back-end environment of the process plant including the process control system 100 includes various components that are shielded and/or protected from the harsh conditions and materials of the field environment. For example, the back-end environment may include the operator workstation 118, the server 112, and/or functionality that support the runtime operations of the process control system 100. In some configurations, various computing devices, databases, and other components and equipment included in the back-end environment of the plant containing the process control system 100 may be physically located at different physical locations, some of which may be local to the process plant and some of which may be remote.

### Example Process Plant Anomaly/Fault Detection Computing Environment

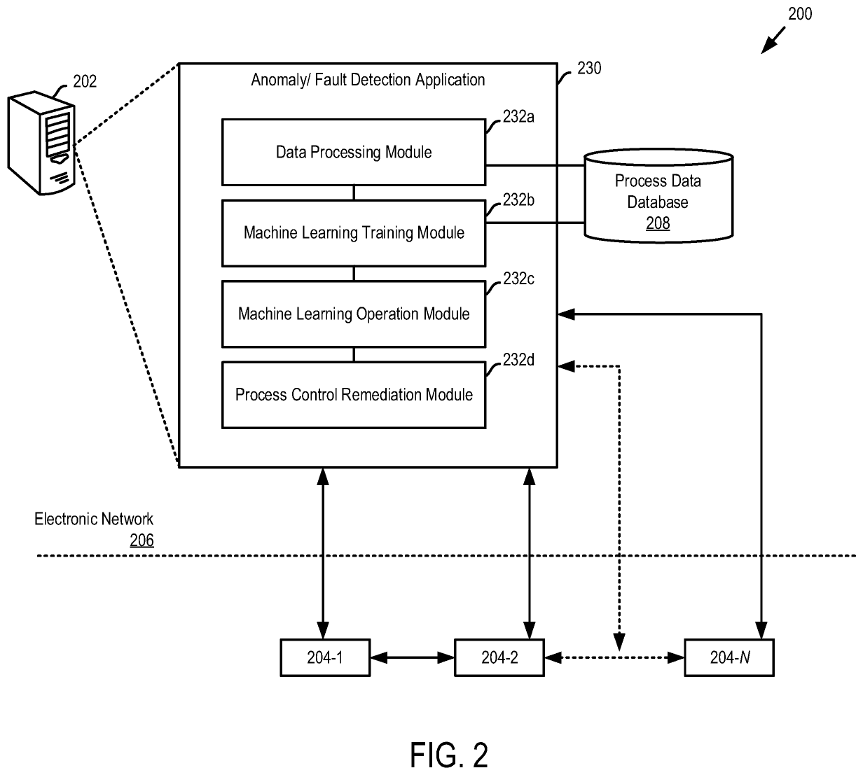

FIG. 2 depicts a block diagram of an example process plant anomaly/fault detection computing environment 200 that may be implemented in a process control system, such as the process control system 100 of FIG. 1, for example. While the example process plant anomaly/fault detection computing environment 200 is described below with reference to devices/components of the process control system 100, it is understood that other systems and/or devices may instead implement the environment 200, in some aspects.

The example process plant anomaly/fault detection computing environment 200 includes an anomaly/fault detection device 202 and a plurality of process data generation devices 204-1 through 204-N that may each perform respective data generation functions associated with a process control system. For example, in some aspects, the anomaly/fault detection device 202 need not be a dedicated device. As used herein, “the anomaly/fault detection device” may be either a dedicated device or any other device that includes computer-executable instructions. For example, the anomaly/fault detection device may be a field device, a mobile computing device, a wearable device, etc.

In some aspects, the anomaly/fault detection device 202 may correspond to the server 112 of FIG. 1. The data generation devices 204 may correspond to the field devices 115-122, the network components 135-170, etc. The process data generation devices 204 may include a number of devices that are integral to the control of a physical process. The process data generation devices 204 may also, or instead, include a number of devices that are associated with the physical process in some other manner.

The devices 204 may communicate with each other and/or other components of the environment 200 via a computer network, and/or other communication means such as direct API libraries, inter-process communication, intra-process communication, remote procedure call, shared memory, etc., and may include or be layered upon wired and/or wireless (e.g., radio frequency) networks. For example, with reference to the process control system 100 of FIG. 1, for example, devices 204 may communicate via the electronic network 206, which may operate on top of the communication network 170 and/or network 180, independently of any protocols associated with those networks (e.g., IEEE 802.11 compliant WLAN, WiMAX, LTE, Bluetooth®, HART®, WirelessHART®, Profibus, Foundation® Fieldbus, etc.) as discussed above.

The process data generation devices 204 may provide and facilitate services within the process plant, such as monitoring services, diagnostic services, analytics services, and so on. For example, the data generation devices 204 may facilitate an operator console service, an alarm management service, an event management service, a diagnostic service, a remote access service, an edge gateway service, an input/output service, a data historian service, an external and/or peripheral input/output translation service, a key performance indication service, a data monitoring service, a message pass-through service, a safety logic service, and/or any other suitable type of service related to control systems. Each of these services may generate service-specific data that may be captured within the process plant anomaly/fault detection computing environment 200.

In some aspects, the anomaly/fault detection device 202 and the process data generation devices 204 may be communicatively coupled via an electronic network 206 (e.g., the network 180 and/or network 170 of FIG. 1). In some aspects, the environment 200 may further include a process data database 208 (e.g., a relational database, a raw file database, a transactional database, a key-value store, a structured query language (SQL) database, a NoSQL database, flat file database, etc.). The database 208 may be stored in the device 202, in some aspects, and/or remotely.

The anomaly/fault detection device 202 may be any suitable computing device, such as a server, laptop, wearable device, mobile device, cloud computing instance, virtual machine, etc. The anomaly/fault detection device 202 may include one or more processors (e.g., one or more central processing units (CPUs), graphics processing units (GPUs), etc.) and one or more persistent and/or transient memories (e.g., one or more magnetic drives, one or more solid state drives, one or more random access memories, etc.) having stored thereon one or more sets of computer-executable instructions. The one or more processors may access the one or more memories and the instructions stored thereon, and execute the instructions stored thereon.

For example, in FIG. 2, the memories of the anomaly/fault detection device 202 may store the anomaly/fault detection application 230. The anomaly/fault detection application 230 may include a plurality of modules, each corresponding to a respective set of computer executable instructions that performs respective functions and operations when executed by the one or more processors of the anomaly/fault detection device 202.

In some aspects, the anomaly/fault detection application 230 includes a data processing module 232a, a machine learning training module 232b, a machine learning operation module 232c and a process control remediation module 232d. It will be appreciated by those of ordinary skill in the art that in some aspects, the modules 232 may include more or fewer modules. For example, in some aspects, the machine learning training module 232b and the machine learning operation module 232c may be combined into a single module. Each of the modules 232 may be able to communicate (e.g., exchange information) with any of the other modules 232. Further, the anomaly/fault detection application 230 may include a set of database client binding instructions (not depicted) that enable any of the modules 232 to create, read, update and/or delete information from one or more electronic databases (e.g., the process data database 208).

The data processing module 232a may include one or more sets of computer-executable instructions for performing data gathering, data pre-processing, data buffering and data storage. Specifically, the data processing module 232a may include instructions for receiving/retrieving process data from standard 4-20 mA devices, the I/O cards 126, 128 and/or smart communication protocol devices such as the Foundation® Fieldbus protocol, the HART® protocol, the WirelessHART® protocol, etc. Process data generally includes data that is generated by various elements of a processing plant while the processing plant is in operation. The data processing module 232a may include software libraries that enable the anomaly/fault detection application 230 to read data from one or more devices located in a process control system (e.g., the process control system 100).

For example, the anomaly/fault detection application 230 may use one or more routines of the data processing module 232a to receive/retrieve data from one or more distributed devices in a process control system on a periodic basis, on a continuous or streaming (e.g., real-time) basis, on a batch basis (e.g., once or more per day at pre-determined intervals) and/or according to any other suitable frequency. In some aspects, the data processing module 232a may include instructions for reading time series data from one or more devices in the process control system, and/or for creating time series data based on data received from the one or more devices of the process control system.

In some aspects, the data processing module 232a may include a thread pool or other parallel processing techniques that enable the data processing module to use distributed computing techniques for receiving, processing, buffering and/or storing data. In some aspects, multiple additional anomaly/fault detection devices 202 are included in the environment 200 to enable the data processing module 232a to scale horizontally via distributed computing. This technique may be particularly advantageous, and provide significant processing improvements, in scenarios wherein the data processing module 232a processes large volumes of data, such as in production plants.

In some aspects, the data processing module 232a may process data from the process plant and store the processed data (e.g., in an electronic database, a memory of the anomaly/fault detection device 202, etc.). At a later time, another module (e.g., the machine learning operation module 232c) may retrieve the stored processed data and conduct further processing of that data. In some aspects, the data processing module 232a may operate in a pass-through mode, wherein the data processing module 232a does not store the data in persistent form for later processing, but rather provides processed data directly to another module (e.g., the machine learning operation module 232c) directly (e.g., via shared/transient memory, a network socket, a message queue, etc.). Those of ordinary skill in the art will appreciate that several different and useful configurations, including distributed computing aspects, are possible, for various scenarios of data collection and processing.

The machine learning training module 232b may include one or more sets of computer-executable instructions for creating, loading, training and/or storing one or more machine learning models. The machine learning training module 232b may train any type of machine learning models, including supervised learning models, unsupervised learning models and/or reinforcement learning models. In some aspects, the machine learning training module 232b may train one or more hybrid machine learning models such as partially-supervised reinforcement learning models. Examples of the types of machine learning modeling techniques that the machine learning training module 232b may use include—without limitation—principal component analysis, artificial neural networks, deep learning, regression, Markov decision processes, etc.

The machine learning training module 232b may include a library of client database bindings that enable the machine learning training module 232b to access an electronic database (e.g., the process data database 208). The machine learning training module 232b may retrieve/receive training data from the process data database 208 and/or from the data processing module 232a. The training data may correspond to historical data from storage (e.g., labeled historical data corresponding to the operation of a process plant) and/or fresher data that has not yet been stored (e.g., process data from a process plant that is in operation). For example, in some aspects, labeled data may include historical knowledge of processes including process stage changes, operation conditions, flaring events, etc. Process data may be labeled according to normal/abnormal status, for example according to whether the data corresponds to a flaring event, or a time period preceding a flaring event (e.g., T-15 minutes, where T is the time of a flaring event).

Fresh data that has not yet been stored may be referred to herein as streaming data, live data or production data. The machine learning training module 232b may use historical and/or streaming data for training one or more machine learning models (e.g., a reinforcement learning model). In some aspects, the machine learning training module 232b may use the library of client database bindings to store information in the electronic database, such as hyperparameters/weights of a trained machine learning model, a serialized/pickled machine learning model, etc.

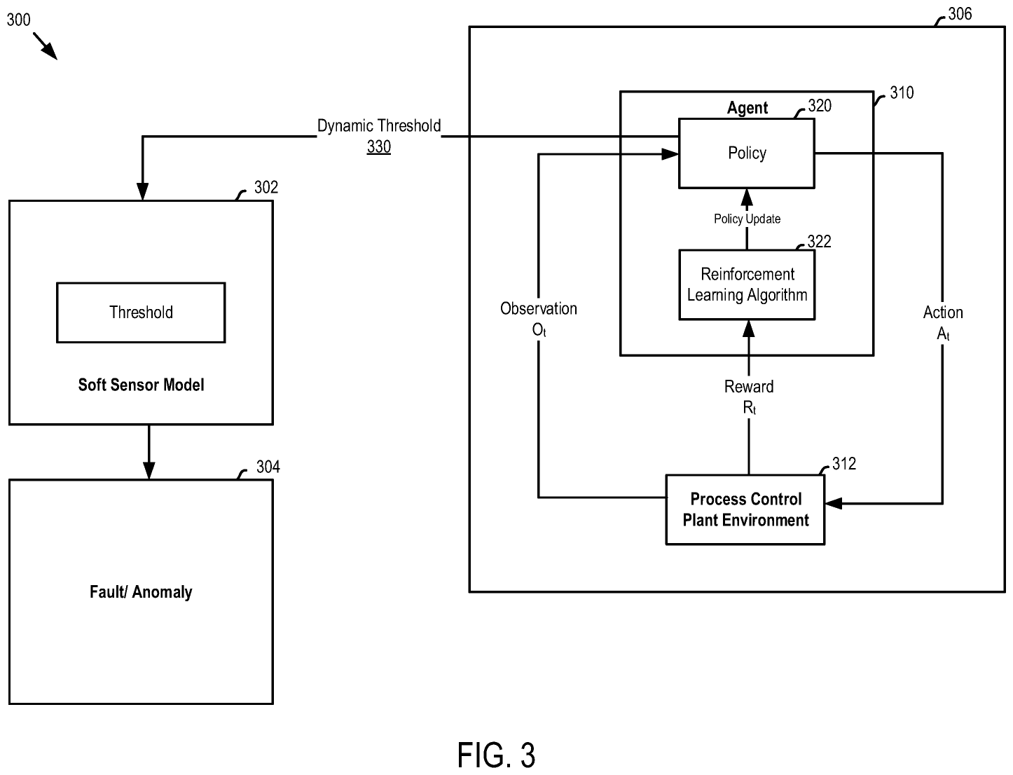

In some aspects, the machine-learning training model may perform model-free training (e.g., Q-learning), for example, by populating state action values in a Q-table. In other aspects, the training may include training an artificial neural network (e.g., a recurrent neural network, LTSM network, etc.) as a function approximator instead of a Q-table. Using a Q-table may advantageously simplify the programming task for the programmer, whereas a function approximation technique may be suitable if the state space is continuous, and/or if there are a large number of states. For example, the machine learning training module 232b may perform training to populate a Q-table as discussed in further detail with respect to FIG. 3, below, for a finite state space=|256| (i.e., state space having a size/cardinality of 256).

The machine learning operation module 232c may include one or more sets of computer-executable instructions for loading, parameterizing, deserializing, and/or operating one or more machine learning models (e.g., the machine learning models trained and/or stored by the machine learning training module 232b). For example, the machine learning operation module 232c may load and operate one or more trained reinforcement learning model (e.g., the reinforcement learning model 300 of FIG. 3). The machine learning operation module 232c may include instructions for receiving/retrieving data (e.g., from the data processing module 232a and/or from the process data database 208), inputting the data into the one or more machine learning models and directing the output of the machine learning models. For example, the machine learning operation module 232c may include instructions for storing the output of one or more machine learning models in the memory of the anomaly/fault detection device 202 and/or the process data database 208.

As discussed with respect to FIG. 3 below, in some aspects, the machine learning operation module 232c may operate multiple machine learning models together, and provide the output of the multiple models to another module (e.g., the process control remediation module 232d) for further processing/analysis.

The process control remediation module 232d may include one or more sets of computer-executable instructions for causing various remedial actions to occur respect to a process plant in response to input. The remedial actions may include positive actions that directly modify the state of the process plant (e.g., actuating a valve, causing a stack to release a gas flare, etc.) and/or passive actions that do not directly modify the state of the process plant (e.g., sounding an alarm, transmitting a notification, displaying an alert, etc.). Thus, the process control remediation module 232d may include computer-executable instructions for directly accessing one or more process control system devices (e.g., the field devices 115-122 of FIG. 1).

The input to the remediation module 232d may be output of another module (e.g., the machine learning operation module 232c). For example, in some aspects, the process control remediation module 232d may receive as input one or more anomaly/fault indications and, based on the indications, cause one or more remediation actions to occur. In some aspects, the process control remediation module 232d may not cause a remedial action to occur. For example, the remediation module 232d may store one or more anomaly/fault indication in the process data database 208.

In operation (e.g., to implement anomaly/fault detection), the data processing module 232a receives process control data (e.g., a time series of process control data) from one or more of the process data generation devices 204. The data processing module 232a processes and/or stores the process control data (e.g., in the process data database 208). As discussed, the data processing module 232a may continuously and/or periodically receive live data. The machine learning operation module 232c receives/retrieves the processed process control data and inputs the process control data into a previously-trained machine learning model (e.g., a reinforcement learning model trained using the machine learning training module 232b). The machine learning operation module 232c receives the output of the trained machine learning model and forwards the output to the process control remediation module 232d, and/or stores the output in the process data database 208. In response to determining that the output of the trained machine learning model received from the machine learning operation module 232c corresponds to an anomalous or fault condition (e.g., by reference to a Q-table, as discussed herein), the process control remediation module 232d causes one or more active or passive actions to occur with respect to the process control system.

In some aspects, the machine learning operation module 232c may cause the trained machine learning model to be updated, in addition to or instead of forwarding its output to the process control remediation module 232d. For example, during an online training mode, the machine learning operation module 232c may cause a pre-trained (or untrained) reinforcement learning model to be trained based on the processed process control data. In some aspects, the data processing module 232a and/or the machine learning training module 232b may be omitted from the environment 200.

### Exemplary Machine Learning-Based Dynamic Threshold Aspects

Turning to FIG. 3, an anomaly/fault detection reinforcement learning pipeline 300 is depicted, according to some aspects. The anomaly/fault detection reinforcement learning pipeline 300 includes a soft sensor model block 302, an anomaly/fault outcome block 304 and a reinforcement learning block 306. The soft sensor model may include a statistical algorithm (e.g., principal component analysis) based on a threshold. As discussed above, soft sensing for anomaly/fault detection has been used with a static/fixed threshold, but a static threshold is problematic for a number of reasons (e.g., the tendency for excessive false positives). Especially with large amounts of process data, it has been conventionally difficult to define a threshold, due to the presence of many potentially triggering events. Thus, in the present techniques, the reinforcement learning pipeline 300 is improved, e.g., by the addition of the reinforcement learning as will now be described in more detail.

In some aspects, the soft sensor model at block 302 is a DeltaV™ control system neural block. The pipeline 300 may use pre-existing, or legacy, soft sensor models computed by the DeltaV™ control system, or another control system, for example. The reinforcement learning at block 306 may be performed by the anomaly/fault detection device 202 and/or one or more of the process data generation devices 204 of FIG. 2, for example. The components of FIG. 2 may exchange information with the soft sensor model at block 302 via the electronic network 206, for example.

At block 302, the soft sensor model includes a principal component analysis algorithm that performs process detection. For example, the soft sensor model may execute the principal component analysis at block 302. In that case, given a new observation xₜ (1×m, m is the number of parameters, where xₜ stands for process measurements collected at time t, such as temperature, flow rates, pressure, concentration, etc.) the principal component analysis performed at block 302 may include preprocessing the data based on the equation

$${\tilde{x}}_{t , i} = \frac{{x}_{t , i} - {\overline{x}}_{i}}{{σ}_{i}}$$

where x̅ᵢ and σᵢ are the mean and standard deviation of the ith training parameter xᵢ, respectively, where

$${\overline{x}}_{i} = \frac{1}{n} {\sum }_{t = 1}^{n} {x}_{t , i}$$

$$and$$

$${σ}_{i} = \sqrt{\frac{{\sum }_{t = 1}^{n} {( {x}_{t , i} - {\overline{x}}_{i} )}^{2}}{n}}$$

Two control charts may be used in process fault detection, namely the Hotelling's T² and the squared prediction error (SPE) or Q statistic:

$${t}_{t} = {\tilde{x}}_{t} P$$

$${\hat{x}}_{t} = {t}_{t} {P}^{T}$$

$${e}_{t} = {\tilde{x}}_{t} - {\hat{x}}_{t}$$

$${T}_{t}^{2} = {\sum }_{i = 1}^{a} {( \frac{{t}_{t , i}}{{λ}_{i}} )}^{2}$$

$${SPE}_{t} = {Q}_{t} = {e}_{t} {e}_{t}^{T}$$

where tₜ (1×a) is the scoring vector for the xₜ (1×m), P (m×a) contains the loading vectors associated with the first a principal components, \hat{x}ₜ (1×m) is the prediction value, eₜ (1×m) is the prediction residual, λᵢ is the standard deviation for the ith component's scores.

At reinforcement learning block 306, the agent 310 may learn based on performing actions and receiving rewards from an unknown process control plant environment 312. In some aspects, the environment 312 may correspond to a process control plant, such as the plant of FIG. 1. In some aspects, the environment 312 may correspond to another, non-process control plant environment. The agent 310 may include a policy 320 and a reinforcement learning algorithm 322. The agent 310 learns to take actions Aₜ, which may affect the state of the environment 312. In response to the actions Aₜ, the environment 312 may generate a reward Rₜ. The reinforcement learning algorithm 322 may process the reward Rₜ and generate a policy update that is received and stored by the policy 320. At the same time, the agent 310 may receive one or more observations Oₜ from the environment 312 and, based on the observations Oₜ, generate and save additional policy updates. In some aspects, the agent 310 seeks to maximize the reward Rₜ, and/or a cumulative reward Qₜ.

It will be appreciated that in some cases, the best action is to do nothing. This corresponds to Table 2 (Action=0), for example. In the agent training process, the agent is learning when to tag state as “faulty/anomaly” (Action=1). Doing nothing (Action=0) does not necessarily lead to bad performance, especially when there is no fault/anomaly actually existing in the process.

The agent's potential action is usually described by a conditional probability π(a, o)=p(Aₜ=a|Oₜ=o), i.e., the probability of action a a given observation o. For example, in some aspects, the reinforcement learning algorithm 322 defines A={0,1} where 1 means that a state Oₜ corresponds to an anomaly/fault state and 0 corresponds to a normal state.

The performance of the policy 320 may be measured based on the following formula:

$${V}_{π} = {\sum }_{o ∈ O} {d}^{π} ( o ) {\sum }_{a ∈ A} Q ( o , a ) \cdot π ( o , a )$$

where d^{π}(o) is the probability of the target system being in the state o under the utilization of the policy mapping π, and Q(o, a) represents the accumulated reward started from the observation o with action a and Q(oₜ, aₜ)=E[Rₜ₊₁+γQ(oₜ₊₁, aₜ₊₁)]. where “E” stands for “expectation”, which is equal to calculating the average of future reward Rₜ₊₁, the product of learning rate γ and future accumulated reward Q(oₜ₊₁, aₜ₊₁) after taking the action aₜ₊₁.

d^{π}(o) may be a constant that only depends on the number of states, i.e.,

$${d}^{π} ( o ) = \frac{1}{N} ,$$

where N is the number of states.

The optimal policy mapping π may satisfy the following formula:

$${π}^{*} = arg {max}_{π} {V}_{π}$$

Since d^{π}(o) is roughly the same for all states o, π(o, a) may be defined to be 1 if

$$a = arg {max}_{a} Q ( o , a ) .$$

In other words, the optimal policy mapping π* may be fully determined by the accumulated reward function Q(o, a).

An experience E may include a set of tuples, each of which is defined as [symbol] o, a, r, o′ [symbol] and records all the behaviors of the policy mapping π (i.e., the policy 320). The values o, o′ may indicate the states of the target system (e.g., the environment 312) before and after the action a, the respectively. In some aspects, r is the instant reward obtained under the state s with the action a. In an anomaly and fault detection system, the actions may be decided based on the policy mapping π (i.e., the policy 320). The reinforcement learning at block 306 may improve the policy 320 by learning from experience E. The experience E and the process control plant environment 312 may include live data and/or historical data. The “E” standards for experience which the agent will learn from to perform better in the fault detection work. Such experience may include new plant data with known operation states for training the agent.

In general, the reinforcement learning at block 306 may include training (e.g., by the machine learning training module 232b of FIG. 2) to learn when conditions in the environment 312 correspond to a fault or anomaly state, as opposed to a condition that represents a false positive. In this way, the reinforcement learning at block 306 may include generating a dynamic threshold 330 that the soft sensor model can receive, and use in place of the previous (e.g., static) threshold 310. Thus, the agent 310 learns to take action Aₜ by interacting with an environment 312.

Advantages of the reinforcement learning pipeline 300 include first, that process engineers are provided with more options to evaluate the status of process operation and to define normal and abnormal operations during training data preparation; and second, that once the training data are obtained, and without making any assumptions for anomaly/fault detection (i.e., whether data are outside the control limits/standard deviation limits), the reinforcement learning pipeline 300 can continuously learn to improve its policies with new experience E. Still further, the present techniques are able to take into account multiple criteria related to processes.

Conventionally, constant control limits for the T² and Q statistics are used for anomaly/fault detection, and are calculated as follows:

$$\begin{matrix}{T}_{U C L}^{2} = \frac{{( n - 1 )}^{2} ( a / ( n - a - 1 ) ) {F}_{α} ( a , n - a - 1 )}{n ( 1 + a / ( n - a - 1 ) ) {F}_{α} ( a , n - a - 1 )} \\ {Q}_{UCL} = ( v / 2 m ) {χ}_{2 {m}^{2} / v , α}^{2}\end{matrix}$$

where v and m are the sample mean and variance of the Q sample, and χ₂ₘ_{²}_{/v,α}² is the critical value of the chi-squared variable with 2m²/v degree of freedom at significance level α.

When preparing training data sets (labeling normal data vs anomaly/fault), besides such control limits, historical knowledge of the process include process stage changes and operation conditions can be exploited. For example, flaring events can be used in labeling process data as normal or abnormal, as discussed above.

Once the training data are prepared with correct labels, the reinforcement learning (RL) framework used for anomaly/fault detection will evolve with experience E, to gain a better estimation of the accumulated reward Q(o, a). Since the policy mapping π (i.e., the policy 320 of FIG. 3) alone makes no assumptions regarding anomaly/fault detection, it is capable of consistently improving its capability with new experience E, and dynamically improve anomaly/fault detection performance.

It will be appreciated by those of ordinary skill in the art that the present techniques are flexible, and many additional use cases are envisioned. For example, the present techniques may be used to predict and detect flaring events. The present techniques may also be used to detect and diagnose suspicious valve behavior (e.g., in relation to a failing valve). The present techniques may be used in control applications having nonlinearities, such as pH control systems and viscosity control systems. Still further, the present techniques may be used to perform measurements with cameras, for learning normal and abnormal patterns in a security context (e.g., network traffic patterns), and for measurement validation (e.g., to detect uncertain or incorrect measurements).

### Exemplary Metric-Reward Table and Q-Table Based Reinforcement Learning Aspects

Table 1 depicts an exemplary metric-reward table that maps metrics to respective rewards, according to some aspects.

TABLE 1
metric-reward table

| Metrics | Reward |
|---|---|
| $\frac{{T}_{t}^{2}}{{T}_{U C L}^{2}} ∈ ( 0 , 1 ]$ | −1 |
| $\frac{{T}_{t}^{2}}{{T}_{U C L}^{2}} ∈ ( 1 , 2 ]$ | +1 |
| $\frac{{T}_{t}^{2}}{{T}_{U C L}^{2}} ∈ ( 2 , 3 ]$ | +2 |
| $\frac{{T}_{t}^{2}}{{T}_{UCL}^{2}} ∈ ( 3 , ∞ )$ | +3 |
| Qₜ/Q_{UCL} ∈ (0, 1] | −1 |
| Qₜ/ Q_{UCL} ∈ (1, 2] | +1 |
| Qₜ/Q_{UCL} ∈ (2, 3] | +2 |
| Qₜ/Q_{UCL} ∈ (3, ∞) | +3 |
| No set point change (α= 0) | 0 |
| Set point occurs (α = 1) | −1 |
| No load disturbance (β = 0) | 0 |
| Load disturbance occurs (β = 1) | −1 |
| No operating stage shift (γ = 0) | 0 |
| Operating stage shift (γ = 1) | −2 |
| No flaring event (δ = 0) | 0 |
| Flaring event (δ = 1) | +10 |

Table 1 includes a metrics column that includes a plurality of possible states, each state representing a particular metric related to the operation of the process plant.

In some aspects, the Table 1 may be generated by the anomaly/fault detection application 230 of FIG. 2. For example, the machine learning training module 232b of the anomaly/fault detection application 230 may establish a database table schema representing Table 1 in the process data database 208, and insert and update reward values into that database table during the training phase. Further, the machine learning operation module 232c may retrieve the reward values by issuing a SELECT query, for example, having a WHEREIN clause, the wherein clause including a value corresponding to metrics. For example, the query “SELECT reward FROM metric_reward WHERE loadDisturbance=True” would return a value of −1.

Similarly, with respect to FIG. 3, the reinforcement learning algorithm 322 may retrieve a reward Rₜ in a similar manner. In some aspects, reinforcement learning algorithm 322 may read the values in the Table 1 into memory prior to operation, to reduce network bandwidth usage.

The first four rows of Table 1 involve evaluating the constant control limits for T² as discussed above. Table 1 associates respective reward values with respective values of T². The next four rows of the Table 1 involve evaluating the Q statistics discussed above, and associate (i.e., map) respective reward values with respective values of Q.

The next two rows of Table 1 hold reward values for application when there has been a set point change (α), and map respective reward values with whether a set point change has occurred. The next two rows of the metric-reward Table 1 involve evaluating whether there has been a load disturbance (β), and map respective reward values with whether a load disturbance has occurred. The next two rows of Table 1 hold reward values for instances where there has been an operating stage shift (γ), and map respective reward values with whether an operating stage shift has or has not occurred. The next two rows of the metric-reward Table 1 hold reward values for instances where there has been a gas flaring event (δ), and map respective reward values with whether a gas flaring event has or has not occurred.

Based on the size of the metric-reward Table 1, and possible values, there may be 256 possible states. The reward of each state (oₜ) may be the sum of the respective rewards of each individual metric in the metric-reward Table 1 for a set of metric values. For example, the state oₜ may be defined as a set of

$$( \frac{{T}_{t}^{2}}{{T}_{UCL}^{2}} , {Q}_{t} / {Q}_{U C L} , α , β , γ , δ ) ,$$

where α=set point change; β=load disturbance; γ=operating stage shift; and δ=gas flaring event. In some aspects, the reward may only be evaluated if the action=1; i.e., the state oₜ is tagged as an anomaly/fault. For example, with a state

$$( \frac{{T}_{t}^{2}}{{T}_{UCL}^{2}} ∈ ( 0 , 1 ] ; \frac{{Q}_{t}}{{Q}_{UCL}} ∈ ( 0 , 1 ] ;$$

no set point change; no load disturbance; no operating stage shift; no flaring event) the total reward is computed as: −1−1+0+0+0+0=−2.

In some aspects, the present techniques may include training a fault detection agent (e.g., the agent 310 of FIG. 3) using historical process plant data for oₜ for each of the 256 possible states (e.g., from index 0-index 255) to populate a Q-table that can be used for future fault detection (i.e., on live process plant data).

Table 2 depicts an exemplary Q-table, according to some aspects.

TABLE 2

Actions

| | Tag the state Oₜ as | Tag the state Oₜ as |
|---|---|---|
| States | fault/anomaly (action = 1) | normal (action = 0) |
| #0 | −35.5 | 0 |
| #1 | 10.5 | 0 |
| #2 | 20.5 | 0 |
| . . . | . . . | . . . |
| #255 | 150.0 | 0 |

Like Table 1, Table 2 may correspond to a table in the process data database 208 of FIG. 2, for example. The machine learning training module 232b may issue UPDATE queries against the database 208 during training to update the values of Table 2. For example, “UPDATE q SET actionFault=10.5, action Normal=0 where state=1.” The machine learning operation module 232c may then retrieve those stored values via a SELECT action Fault, action Normal FROM q WHERE state=1.” The reinforcement learning algorithm 322 of FIG. 3 may perform similar SQL updates, and select values.

Each row of Table 2 corresponds to a possible state, wherein each state includes an index, a respective anomalous bound (action=1) value, and a respective normal bound (action=0). Each state corresponds to a unique set of the metrics in the metrics-reward Table 1. The agent in a reinforcement learning model (e.g., the agent 310 of FIG. 3) may use Table 2 (i.e., the Q-table) to determine which state oₜ the plant is in at a particular time t, represented as Q(oₜ, aₜ)=E[Rₜ₊₁+γQ(oₜ₊₁, aₜ₊₁)] where “E” stands for “expectation”, which is equal to calculating the average of future reward Rₜ₊₁, the product of learning rate γ and future accumulated reward Q(oₜ₊₁, aₜ₊₁) after taking the action aₜ₊₁, and select the action value from the Q-table based on the reward (e.g., by selecting the higher reward, in some aspects). The action value (i.e., 1 or 0) may respectively correspond to whether the state of a given combination of values is in an anomaly/fault state or a normal state.

For example, consider state[0]:

$$\frac{{T}_{t}^{2}}{{T}_{UCL}^{2}} ∈ ( 0 , 1 ] , {Q}_{t} / {Q}_{UCL} ∈ ( 0 , 1 ] ,$$

no set point change, no load disturbance, no operating stage shift, no flaring event. Because the Q(oₜ, aₜ) is −35.5 for tagging the state as an anomaly/fault, the agent will prefer to tag the state as normal instead because (Q=0>−35.5). In another example, consider state[1]:

$$\frac{{T}_{t}^{2}}{{T}_{UCL}^{2}} ∈ ( 1 , 2 ] , {Q}_{t} / {Q}_{U C L} ∈ ( 0 , 1 ] ,$$

no set point change, no load disturbance, no operating stage shift, no flaring event. Because (0=10.5>0), in this case, the agent will tag the state as an anomaly/fault. In still another example, consider state[2]:

$$\frac{{T}_{t}^{2}}{{T}_{U C L}^{2}} ∈ ( 2 , 3 ] , ( {Q}_{t} / {Q}_{U C L} ∈ ( 0 , 1 ] ,$$

no set point change, no load disturbance, no operating stage shift, no flaring event. In this example, the agent will tag the state as an anomaly/fault because Q=20.5>0. In yet another example, consider state[255]:

$$\frac{{T}_{t}^{2}}{{T}_{U C L}^{2}} ∈ ( 3 , ∞ ) , {Q}_{t} / {Q}_{U C L} ∈ ( 3 , ∞ ) , ,$$

set point change, load disturbance, operating stage shift, flaring event. There, since Q(oₜ, aₜ)=150, and 150>0, the agent will tag the state as an anomaly/fault.

Table 2 reflects the advantageous dynamic nature of the present techniques. Consider again state [1]. Over time, the training may adjust the value of the anomaly/fault value and/or the normal value, such that the normal value exceeds the anomaly/fault value. In that case, state[1] will no longer be an anomaly/fault state, and will instead switch to being a normal state. It will be appreciated that in some aspects, a tie may occur. In such cases, the state may be resolved as having an action of 1 (i.e. anomaly/fault). This dynamic behavior is in contrast to conventional techniques, only allowed the selection of a static value. As shown in FIG. 3, the Q-table values may correspond to dynamic thresholds (e.g., the dynamic threshold 330) that can learn over time to improve various aspects of the anomaly/fault detection (e.g., to avoid false positives). The user may provide feedback to the training in order to guide the system to better respective action values.

As discussed above, in some aspects, the present technique may include using one or more cameras in conjunction with the reinforcement learning aspects. For example, the process control system 100 may include one or more camera devices. The one or more camera devices may measure an aspect of the process plant (e.g., a level in a tank, a flare stack, a furnace burner, etc.). For example, the one or more cameras may include an invisible spectrum sensor that measures a spectrum or shape of a curve. In this case, the present techniques may include training an artificial neural network and/or convolutional neural network to determine an anomaly/fault state, for example, by the machine learning training module 232b of FIG. 2.

### Example Edge Computing Device

It will be appreciated that in some aspects, it may be advantageous to locate the trained machine learning model and associated data (e.g., the metrics-reward table and/or Q-table) to a device or node that is deeper (i.e., at a lower level) within the process plant (e.g., one or more of the process data generation devices 204. Doing so may lead to several advantages. First, the computational load may be distributed from the anomaly/fault detection device 202 amongst the process data generation devices 204. Second, by locating the trained machine learning model proximate to the anomaly/fault detection device 202, where the generation of data occurs, the network resource consumption that would ordinarily be required to move the data to a backend are eliminated. For a large process plant, this may result in a dramatic freeing-up of network bandwidth. Third, by processing the data locally at the process data generation devices 204, the present technique avoid a round-trip that may add latency to the anomaly/fault detection and prediction techniques discussed herein.

In such aspects, one or more of the process data generation devices 204 may receive machine-learned information (e.g., a trained machine learning model, an artificial neural network, a metric-reward table, a Q-table, ec.) from the anomaly/fault detection application 230. The anomaly/fault detection application 230 may include instructions for activating local processing of one or more of the process data generation devices 204. In this way, the anomaly/fault detection application 230 may configure the process data generation devices 204 to perform load balancing of the process data. This technique may also advantageously enable the present techniques to selectively distribute load to only those devices that are capable of performing the local processing (e.g., those process data generation devices 204 that have been upgraded and include the software and hardware necessary to execute machine learning models and/or other customized instruction sets at the edge).

### Exemplary Methods

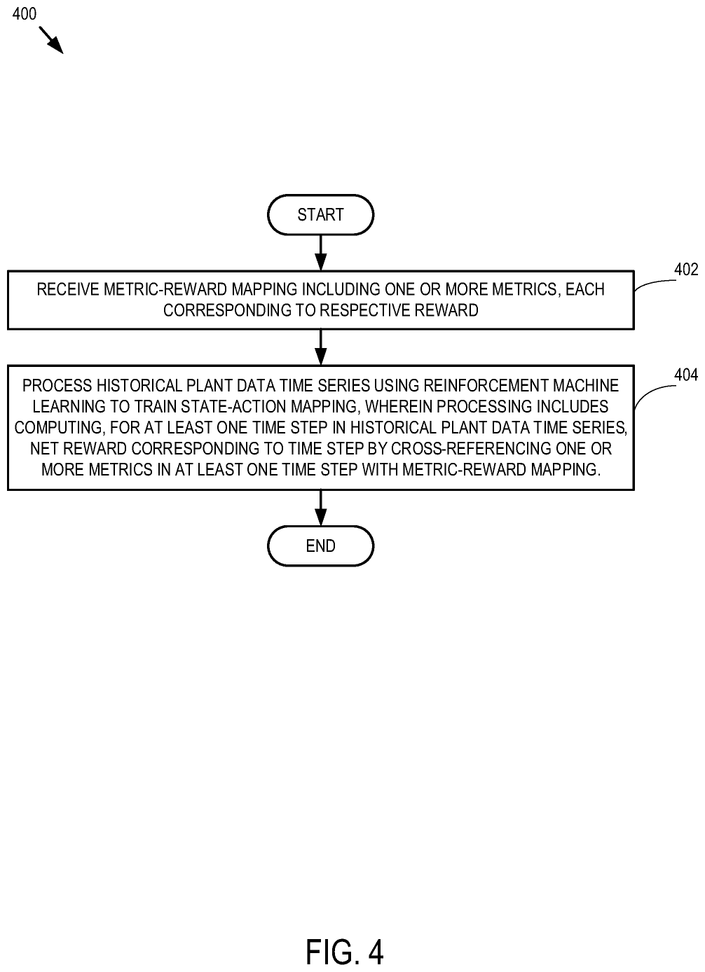

FIG. 4 depicts a flow diagram representing an exemplary method 400 for improving anomaly/fault detection and/or mitigation in a process control plant by using reinforcement learning to avoid false alarms, according to some aspects. The method 400 may be executed by one or more physical devices of a process control system that implements a physical process, such as the process control system 100 of FIG. 1, for example. For instance, the method 400 may be implemented by the controller 111, and/or by one or more other physical devices in the process control system 100 (e.g., operator workstation 108, server 112, one or more of field devices 115-122 and/or 140-150, I/O device 126 and/or 128, network device 135, etc.). In some aspects, the method 400 may be performed using the components of the environment 200 of FIG. 2 (e.g., the anomaly/fault detection device 202 and the plurality of process data generation devices 204).

The method 400 may include receiving a metric-reward mapping including one or more metrics, each corresponding to a respective reward (block 402). For example, the method 400 may receive a metrics-reward table such as Table 1. Of course, there may be more or fewer metrics, in some aspects. The rewards may differ, as well, and also, the metrics themselves may differ. For example, some types of processes may lack a stage shift, and in such cases, the y variable may be omitted. In some aspects, the method 400 may receive a metric-reward in a different format (e.g., in a JSON or XML format). A table is chosen for convenience, but the data may be represented in a computer using any suitable data structure/data format.

The method 400 may include processing an historical plant data time series using reinforcement machine learning to train an state-action mapping (block 404). Specifically, the reinforcement machine learning may be performed at block 306 as discussed with respect to FIG. 3, where the training seeks to maximize a reward. For example, the the method 400 may include taking an action Aₜ that affects the state of an environment (e.g., the process plant); receiving a reward Rₜ based on the action (e.g., the reward associated with one or more metrics at a next time step); observing the reward Rₜ; and updating a policy in order to maximize a cumulative reward of which the reward Rₜ is a part.

In some aspects, the processing at block 404 includes computing, for at least one time step in the historical plant data time series, a net reward corresponding to the time step by cross-referencing one or more metrics in the at least one time step with the metric-reward mapping. In other words, the reinforcement learning at block 404 may include computing a respective reward value for each of the metrics in the Table 1, and then the value of each respective reward value may be summed to arrive at a net reward. As discussed above, for a state of

$$( \frac{{T}_{t}^{2}}{{T}_{UCL}^{2}} ∈ ( 0 , 1 ] ; \frac{{Q}_{t}}{{Q}_{UCL}} ∈ ( 0 , 1 ] ;$$

no set point change; no load disturbance; no operating stage shift; no flaring event), the respective rewards equal (−1−1+0+0+0+0) and the net reward equals −2.

In some aspects, the method 400 may include generating a Q-table including a plurality of states, each state having a respective anomaly/fault action value and a respective normal action value. Specifically, in some aspects, a side-effect or result of the training at block 404 may be a Q-table such as the Table 2, above.

As in the example of Table 1 and Table 2, the cardinality of the Q-table i.e., |Q-table| may be determined by multiplying the number of possible metrics states together using the rule of products. Thus, since there are 4 possible T2 states, 4 possible Q states, 2 possible set point states, 2 possible load disturbance states, 2 possible operating stage shift states and 2 possible flaring states, the cardinality of the Q table in the example is computed by 4×4×2×2×2×2, which equals cardinality of |256|. Therefore, in some aspects, the size of the Q-table may be 256.

As noted, when the Q-table grows larger (e.g., due to a larger number of metrics, continuous metrics, etc.), a function approximation approach (e.g., using an artificial neural network, such as a recurrent neural network) may be more suitable. In that case, the method 400 may include training the artificial neural network to act as a function approximator, such that the artificial neural network processes state input and directly predicts (i) an anomaly/fault action value, and (ii) a normal action value; or a Boolean action value corresponding to whether the state is an anomaly/fault state, or not.

In some aspects, the metrics of method 400 may include i) a pre-defined statistical threshold, ii) a pre-defined constant control limit, iii) a set point indicator, iv) load disturbance indicator, v) an operating stage shift indicator; or vi) a flaring event indicator. Reward values are generally expressed as integers (e.g., negative or positive whole numbers) wherein positive values are associated with faults/anomalies, and negative values are associated with non-fault/non-anomalous behavior. For example, metrics indicative of human-initiated and thus, likely intentional acts (e.g., a set point change) have negative reward values, which effectively teaches the agent that such data points should not be classified as faults/anomalies (and thus should not result in passive or active mitigation/remediation). Similarly, the reward values associated with flaring metrics may be relatively large, given that the events associated with such metrics are considered to always be significant and unmistakable indications of faults/anomalies. Of course, those of ordinary skill in the at will appreciate that the sign of the integer rewards may be trivially reversed, in some aspects.

In some aspects, the pre-defined statistical threshold and the pre-defined constant control limit of the method 400 are defined, respectively, as

$${T}_{U C L}^{2} = \frac{{( n - 1 )}^{2} ( a / ( n - a - 1 ) ) {F}_{α} ( a , n - a - 1 )}{n ( 1 + a / ( n - a - 1 ) ) {F}_{α} ( a , n - a - 1 )}$$

$$and$$

$$QUCL = ( v / 2 m ) {χ}_{2 {m}^{2} / v , α}^{2} ,$$

wherein T² is Hotelling's T-squared distribution and Q is a squared prediction error (SPE) statistic;
wherein v and m are, respectively, a sample mean and a variance of a Q sample; and
wherein χ₂ₘ_{²}_{/v,α}² is a critical value of a chi-squared variable with 2m²/v degree of freedom at significance level α.

In some aspects, each time step in the historical plant data time series may be labeled as corresponding to one of i) a fault state or ii) a normal state. In this way, the training process of the method 400 may learn to associate certain states with either anomaly/fault actions, or normal actions. As discussed above, the method 400 may include preprocessing the historical plant data time series. This may be performed when, for example, the historical plant data includes data generated by heterogeneous devices that must be harmonized or combined before processing. The method 400 may include storing some of the historical plant data, for example in a memory (e.g., the memory of the anomaly/fault detection device 202, the process data database 208, etc.).

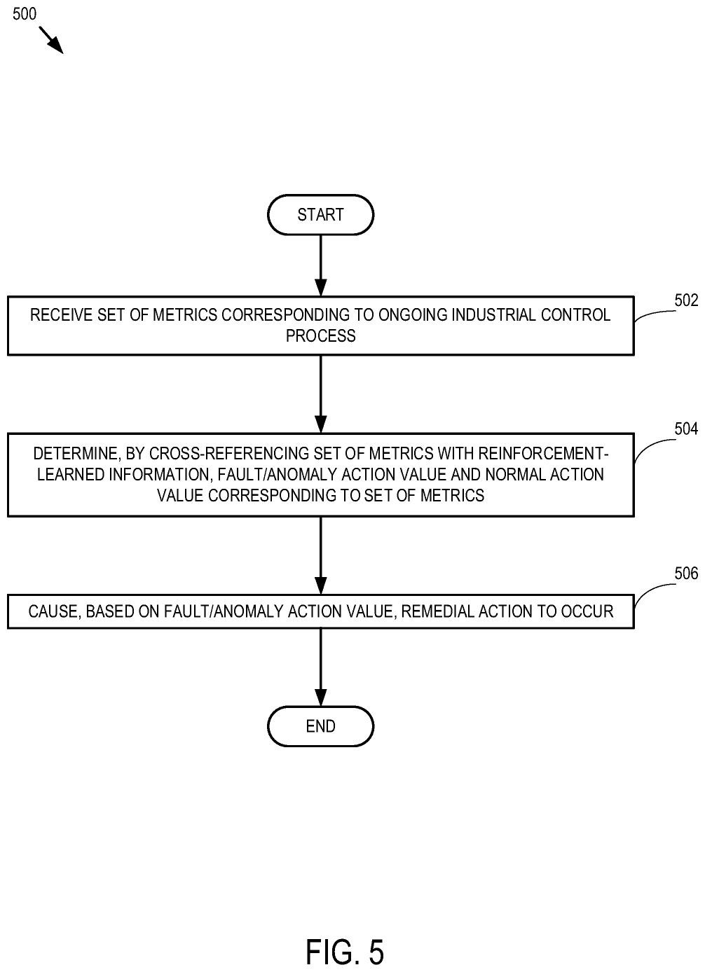

FIG. 5 depicts a flow diagram representing an exemplary method 500 for improving plant safety and environmental impact by processing reinforcement-learned information to determine a plant anomaly/fault, according to some aspects. The method 500 may be executed by one or more physical devices of a process control system that implements a physical process, such as the process control system 100 of FIG. 1, for example. For instance, the method 500 may be implemented by the controller 111, and/or by one or more other physical devices in the process control system 100 (e.g., operator workstation 108, server 112, one or more of field devices 115-122 and/or 140-150, I/O device 126 and/or 128, network device 135, etc.). In some aspects, the method 500 may be performed using the components of the environment 200 of FIG. 2 (e.g., the anomaly/fault detection device 202 and the plurality of process data generation devices 204).

The method 500 may include receiving a set of metrics corresponding to an ongoing industrial control process (block 502). For example, the set of metrics may be included in a time series data set corresponding to the operation of the process plant. The metrics may include at least one of: i) a pre-defined statistical threshold, ii) a pre-defined constant control limit, iii) a set point indicator, iv) load disturbance indicator, v) an operating stage shift indicator; or vi) a flaring event indicator. In some aspects, the method 500 may include generating the set of metrics by preprocessing process control data generated by one or more devices in a process plant, such as a sensor, a valve, a transmitter, a positioner, a standard 4-20 mA device, a field device, a HART® device, a Foundation® Fieldbus device, a Profibus device, a DeviceNet device, a ControlNet device; and/or a Modbus device.

The method 500 may include determining, by cross-referencing the set of metrics with the reinforcement-learned information, an anomaly/fault action value and a normal action value corresponding to the set of metrics (block 504). In some aspects, the reinforcement-learned information in the method 500 may include a reinforcement-learned Q-table (e.g., above Table 2). In some aspects, the reinforcement-learned information in the method 500 may include a function approximation output of a trained artificial neural network (e.g., a recurrent neural network), as described herein.

The method 500 may include causing, based on the anomaly/fault action value, a remedial action to occur (block 506). In some aspects, the remedial action of the method 500 is a passive remedial action, such that the action does not directly cause any physical change to the process plant. For example, such passive or indirect remediation may include (i) sounding an alarm, (ii) transmitting a notification and/or (iii) displaying an alert.

In some aspects, the remedial action of the method 500 may be an active remedial action, such as (i) actuating a valve, (ii) causing a stack to release a gas flare, (iii) performing an action with respect to the plant, etc.

Aspects of the techniques described in the present disclosure may include any number of the following aspects, either alone or combination:
1. A computer-implemented method for improving anomaly/fault detection and/or mitigation in a process control plant, comprising: receiving a metric-reward mapping including one or more metrics, each corresponding to a respective reward; and processing an historical plant data time series using reinforcement machine learning to train a state-action mapping, wherein the processing includes computing, for at least one time step in the historical plant data time series, a net reward corresponding to the time step by cross-referencing one or more metrics in the at least one time step with the metric-reward mapping.
2. The computer-implemented method of aspect 1, wherein processing the historical plant data time series using reinforcement machine learning to train the state-action mapping includes: generating a Q-table including a plurality of states, each state having a respective anomaly/fault action value and a respective normal action value.
3. The computer-implemented method of any one of aspect 2, wherein a cardinality of the Q-table is defined via the rule of product with respect to a number of possible different rewards for each of the metrics.
4. The computer-implemented method of any one of aspect 3, wherein the size of the Q-table is 256.
5. The computer-implemented method of aspect 4, wherein processing the historical plant data time series using reinforcement machine learning to train the state-action mapping includes: training an artificial neural network to act as a function approximator for classifying an input as corresponding to one of (i) an anomaly/fault action value, and (ii) a normal action value.
6. The computer-implemented method of aspect 5, wherein the artificial neural network is a recurrent neural network.
7. The computer-implemented method of aspect 1, wherein the metrics include at least one of: (i) a pre-defined statistical threshold, (ii) a pre-defined constant control limit, (iii) a set point indicator, (iv) load disturbance indicator, (v) an operating stage shift indicator; or (vi) a flaring event indicator.
8. The computer-implemented method of aspect 7, wherein the pre-defined statistical threshold and the pre-defined constant control limit are defined, respectively, as

$${T}_{U C L}^{2} = \frac{{( n - 1 )}^{2} ( a / ( n - a - 1 ) ) {F}_{α} ( a , n - a - 1 )}{n ( 1 + a / ( n - a - 1 ) ) {F}_{α} ( a , n - a - 1 )}$$

$$and$$

$$QUCL = ( v / 2 m ) {χ}_{2 {m}^{2} / v , α}^{2} ,$$

wherein T² is Hotelling's T-squared distribution and Q is a squared prediction error (SPE) statistic;
wherein v and m are, respectively, a sample mean and a variance of a Q sample; and
wherein χ₂ₘ_{²}_{/v,α}² is a critical value of a chi-squared variable with 2m²/v degree of freedom at significance level α.
9. The computer-implemented method of aspect 1, wherein each respective reward value is expressed as an integer.
10. The computer-implemented method of aspect 1, wherein each time step in the historical plant data time series is labeled as corresponding to one of i) a fault state or ii) a normal state.
11. The computer-implemented method of any one of aspects 1 through 10, further comprising: preprocessing the historical plant data time series.
12. The computer-implemented method of any one of aspects 1 through 11, further comprising: storing at least some of the historical plant data time series in an electronic database.
13. The computer-implemented method of aspect 1, wherein processing the historical plant data time series using reinforcement machine learning to train the state-action mapping includes: taking an action Aₜ that affects the state of an environment; receiving a reward Rₜ based on the action; observing the reward Rₜ; and updating a policy in order to maximize a cumulative reward of which the reward Rₜ is a part.
14. A computer-implemented method for improving plant safety and environmental impact anomaly/fault, the method comprising: receiving a set of metrics corresponding to an ongoing industrial control process; determining, by cross-referencing the set of metrics with reinforcement-learned information, an anomaly/fault action value and a normal action value corresponding to the set of metrics; and causing, based on the anomaly/fault action value, a remedial action to occur.
15. The computer-implemented method of aspect 14, wherein the set of metrics corresponding to the ongoing industrial control process include at least one of: (i) a pre-defined statistical threshold, (ii) a pre-defined constant control limit, (iii) a set point indicator, (iv) load disturbance indicator, (v) an operating stage shift indicator; or (vi) a flaring event indicator.
16. The computer-implemented method of any one of aspects 14 through 15, further comprising: generating the set of metrics by preprocessing process control data generated by one or more devices in a process plant.
17. The computer-implemented method of aspect 16, wherein the one or more devices in the process plant include at least one of: a sensor, a valve, a transmitter, a positioner, a standard 4-20 mA device, a field device, a HART® device, a Foundation® Fieldbus device, a Profibus device, a DeviceNet device, a ControlNet device; or a Modbus device.
18. The method of aspect 14, wherein the reinforcement-learned information includes a reinforcement-learned Q-table.
19. The method of aspect 14, wherein the reinforcement-learned information includes a function approximation output of a trained artificial neural network.
20. The method of aspect 19, wherein the trained artificial neural network is a recurrent neural network.
21. The computer-implemented method of aspect 14, wherein the remedial action is a passive remedial action.
22. The computer-implemented method of aspect 21, wherein the passive remedial action includes at least one of (i) sounding an alarm, (ii) transmitting a notification, or (iii) displaying an alert.
23. The computer-implemented method of aspect 14, wherein the remedial action is an active remedial action.
24. The computer-implemented method of aspect 23, wherein the active remedial action includes at least one of (i) actuating a valve, (ii) causing a stack to release a gas flare, or (iii) performing an action with respect to the plant.
25. A process control system comprising: a plurality of process data generation devices, including one or more field devices configured to generate data corresponding to an ongoing industrial control process implemented by the process control system; and an electronic network that communicatively couples at least some of the plurality of process data generation devices to an anomaly/fault detection device, wherein the anomaly/fault detection device includes a memory having stored thereon computer-executable instructions that, when executed by one or more processors of the anomaly/fault detection device, cause the anomaly/fault detection device to: receive a set of metrics corresponding to the ongoing industrial control process; determine, by cross-referencing the set of metrics with reinforcement-learned information, an anomaly/fault action value and a normal action value corresponding to the set of metrics; and cause, based on the anomaly/fault action value, a remedial action to occur.
26. The process control system of aspect 25, wherein the set of metrics corresponding to the ongoing industrial control process include at least one of: (i) a pre-defined statistical threshold, (ii) a pre-defined constant control limit, (iii) a set point indicator, (iv) load disturbance indicator, (v) an operating stage shift indicator; or (vi) a flaring event indicator.
27. The process control system of any one of aspects 25-26, wherein the anomaly/fault detection device includes a memory having stored thereon computer-executable instructions that, when executed by one or more processors of the anomaly/fault detection device, cause the anomaly/fault detection device to: generate the set of metrics by preprocessing process control data generated by the plurality of process data generation devices.
28. The process control system of aspect 25, wherein the plurality of process data generation devices in the process plant include at least one of: a sensor, a valve, a transmitter, a positioner, a standard 4-20 mA device, a field device, a HART® device, a Foundation® Fieldbus device, a Profibus device, a DeviceNet device, a ControlNet device; or a Modbus device.
29. The process control system of aspect 25, wherein the reinforcement-learned information includes a reinforcement-learned Q-table.
30. The process control system of aspect 25, wherein the reinforcement-learned information includes a function approximation output of a trained artificial neural network.
31. The process control system of aspect 30, wherein the trained artificial neural network is a recurrent neural network.
32. The process control system of aspect 25, wherein the remedial action is a passive remedial action.
33. The process control system of aspect 32, wherein the passive remedial action includes at least one of (i) sounding an alarm, (ii) transmitting a notification, or (iii) displaying an alert.
34. The process control system of aspect 25, wherein the remedial action is an active remedial action.
35. The process control system of aspect 34, wherein the active remedial action includes at least one of (i) actuating a valve or (ii) causing a stack to release a gas flare, or (iii) performing an action with respect to the plant.
36. One or more data generation devices configured to: receive reinforcement-learned information; generate data corresponding to an ongoing industrial control process of a process control system; and process the generated data using the received reinforcement-learned information.
37. The one or more data generation devices of aspect 36, wherein each of the data generation devices is at least one of: a sensor, a valve, a transmitter, a positioner, a standard 4-20 mA device, a field device, a HART® device, a Foundation® Fieldbus device, a Profibus device, a DeviceNet device, a ControlNet device; or a Modbus device.
38. The one or more data generation devices of aspect 36, wherein the devices are further configured to: generate the data corresponding to the ongoing industrial control process of the process control system in response to receiving an activation instruction from a remote anomaly/fault detection application.
39. The one or more data generation devices of aspect 36, wherein the received reinforcement-learned information includes a metrics-reward and a Q-table.
40. The one or more data generation devices of aspect 36, wherein the reinforcement-learned information includes a function approximation output of a trained artificial neural network.
41. The one or more data generate devices of aspect 40, wherein the trained artificial neural network is a recurrent neural network.
42. The one or more data generation devices of any one of aspects 36 through 41, wherein the devices are further configured to: compute a set of metrics corresponding to the ongoing industrial process; determine, by cross-referencing the set of metrics with the reinforcement learned information, an anomaly/fault action value and a normal action value corresponding to the set of metrics; and cause, based on the anomaly/fault action value, a remedial action to occur.
43. The one or more data generation devices of aspect 42, wherein the remedial action is a passive remedial action.
44. The one or more data generation devices of aspect 43, wherein the passive remedial action includes at least one of (i) sounding an alarm, (ii) transmitting a notification or (iii) displaying an alert.
45. The one or more data generation devices of aspect 44, wherein the remedial action is an active remedial action.
46. The one or more data generation devices of aspect 45, wherein the active remedial action includes at least one of (i) actuating a valve or (ii) causing a stack to release a gas flare, or (iii) performing an action with respect to the plant.
47. The one or more data generation devices of aspect 42, wherein the remedial action includes causing at least one of the one or more data generation devices to stop generating the data corresponding to the ongoing industrial control process of a process control system.
48. The one or more data generation devices of any one of aspects 36 through 47, further configured to: transmit the generated data to one or both of (i) another data generation device, and (iii) a remote anomaly/fault detection device.
49. The one or more data generation devices of any one of aspects 36 through 48, further configured to: receive, in response to the transmitting, updated reinforcement-learned information.

When implemented in software, any of the applications, services, and engines described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed aspects without departing from the spirit and scope of the invention.

What is claimed:

1. A computer-implemented method for improving anomaly/fault detection and/or mitigation in a process control plant, comprising:
receiving a metric-reward mapping including one or more metrics, each corresponding to a respective reward; and
processing an historical plant data time series using reinforcement machine learning to train a state-action mapping,
wherein the processing includes computing, for at least one time step in the historical plant data time series, a net reward corresponding to the time step by cross-referencing one or more metrics in the at least one time step with the metric-reward mapping.

2. The computer-implemented method of claim 1, wherein processing the historical plant data time series using reinforcement machine learning to train the state-action mapping includes:
generating a Q-table including a plurality of states, each state having a respective anomaly/fault action value and a respective normal action value.

3. The computer-implemented method of claim 2, wherein a cardinality of the Q-table is defined via the rule of product with respect to a number of possible different rewards for each of the metrics.

4. The computer-implemented method of claim 3, wherein the size of the Q-table is 256.

5. The computer-implemented method of claim 1, wherein processing the historical plant data time series using reinforcement machine learning to train the state-action mapping includes:
training an artificial neural network to act as a function approximator for classifying an input as corresponding to one of (i) an anomaly/fault action value, and (ii) a normal action value.

6. The computer-implemented method of claim 5, wherein the artificial neural network is a recurrent neural network.

7. The computer-implemented method of claim 1, wherein the metrics include at least one of:
(i) a pre-defined statistical threshold,
(ii) a pre-defined constant control limit,
(iii) a set point indicator,
(iv) load disturbance indicator,
(v) an operating stage shift indicator; or
(vi) a flaring event indicator.

8. The computer-implemented method of claim 7, wherein the pre-defined statistical threshold and the pre-defined constant control limit are defined, respectively, as
$${T}_{UCL}^{2} = \frac{{( n - 1 )}^{2} ( a / ( n - a - 1 ) ) {F}_{α} ( a , n - a - 1 )}{n ( 1 + a / ( n - a - 1 ) ) {F}_{α} ( a , n - a - 1 )}$$
$$and$$
$$QUCL = ( v / 2 m ) {χ}_{2 {m}^{2} / v , α}^{2} ,$$
wherein T² is Hotelling's T-squared distribution and Q is a squared prediction error (SPE) statistic;
wherein v and m are, respectively, a sample mean and a variance of a Q sample; and
wherein χ₂ₘ_{²}_{/v,α}² is a critical value of a chi-squared variable with 2m²/v degree of freedom at significance level α.

9. The computer-implemented method of claim 1, wherein each respective reward value is expressed as an integer.

10. The computer-implemented method of claim 1, wherein each time step in the historical plant data time series is labeled as corresponding to one of i) a fault state or ii) a normal state.

11. The computer-implemented method of claim 1, further comprising:
preprocessing the historical plant data time series.

12. The computer-implemented method of claim 1, further comprising:
storing at least some of the historical plant data time series in an electronic database.

13. The computer-implemented method of claim 1, wherein processing the historical plant data time series using reinforcement machine learning to train the state-action mapping includes:
taking an action Aₜ that affects the state of an environment;
receiving a reward Rₜ based on the action;
observing the reward Rₜ; and
updating a policy in order to maximize a cumulative reward of which the reward Rₜ is a part.

14. A computer-implemented method for improving plant safety and environmental impact anomaly/fault, the method comprising:
receiving a set of metrics corresponding to an ongoing industrial control process;
determining, by cross-referencing the set of metrics with reinforcement-learned information, an anomaly/fault action value and a normal action value corresponding to the set of metrics; and
causing, based on the anomaly/fault action value, a remedial action to occur.

15. The computer-implemented method of claim 14, wherein the set of metrics corresponding to the ongoing industrial control process include at least one of:
(i) a pre-defined statistical threshold,
(ii) a pre-defined constant control limit,
(iii) a set point indicator,
(iv) load disturbance indicator,
(v) an operating stage shift indicator; or
(vi) a flaring event indicator.

16. The computer-implemented method of claim 14, further comprising:
generating the set of metrics by preprocessing process control data generated by one or more devices in a process plant.

17. The computer-implemented method of claim 16, wherein the one or more devices in the process plant include at least one of:
a sensor,
a valve,
a transmitter,
a positioner,
a standard 4-20 mA device,
a field device,
a HART® device,
a Foundation® Fieldbus device,
a Profibus device,
a DeviceNet device,
a ControlNet device; or
a Modbus device.

18. The method of claim 14, wherein the reinforcement-learned information includes a reinforcement-learned Q-table.

19. The method of claim 14, wherein the reinforcement-learned information includes a function approximation output of a trained artificial neural network.

20. The method of claim 19, wherein the trained artificial neural network is a recurrent neural network.

21. The computer-implemented method of claim 14, wherein the remedial action is a passive remedial action.

22. The computer-implemented method of claim 21, wherein the passive remedial action includes at least one of (i) sounding an alarm, (ii) transmitting a notification, or (iii) displaying an alert.

23. The computer-implemented method of claim 14, wherein the remedial action is an active remedial action.

24. The computer-implemented method of claim 23, wherein the active remedial action includes at least one of (i) actuating a valve, (ii) causing a stack to release a gas flare, or (iii) performing an action with respect to the plant.

25. A process control system comprising:
a plurality of process data generation devices, including one or more field devices configured to generate data corresponding to an ongoing industrial control process implemented by the process control system; and
an electronic network that communicatively couples at least some of the plurality of process data generation devices to an anomaly/fault detection device,
wherein the anomaly/fault detection device includes a memory having stored thereon computer-executable instructions that, when executed by one or more processors of the anomaly/fault detection device, cause the anomaly/fault detection device to:
receive a set of metrics corresponding to the ongoing industrial control process;
determine, by cross-referencing the set of metrics with reinforcement-learned information, an anomaly/fault action value and a normal action value corresponding to the set of metrics; and
cause, based on the anomaly/fault action value, a remedial action to occur.

26. The process control system of claim 25, wherein the set of metrics corresponding to the ongoing industrial control process include at least one of:
(i) a pre-defined statistical threshold,
(ii) a pre-defined constant control limit,
(iii) a set point indicator,
(iv) load disturbance indicator,
(v) an operating stage shift indicator; or
(vi) a flaring event indicator.

27. The process control system of claim 25, wherein the anomaly/fault detection device includes a memory having stored thereon computer-executable instructions that, when executed by one or more processors of the anomaly/fault detection device, cause the anomaly/fault detection device to:
generate the set of metrics by preprocessing process control data generated by the plurality of process data generation devices.

28. The process control system of claim 25, wherein the plurality of process data generation devices in the process plant include at least one of:
a sensor,
a valve,
a transmitter,
a positioner,
a standard 4-20 mA device,
a field device,
a HART® device,
a Foundation® Fieldbus device,
a Profibus device,
a DeviceNet device,
a ControlNet device; or
a Modbus device.

29. The process control system of claim 25, wherein the reinforcement-learned information includes a reinforcement-learned Q-table.

30. The process control system of claim 25, wherein the reinforcement-learned information includes a function approximation output of a trained artificial neural network.

31. The process control system of claim 30, wherein the trained artificial neural network is a recurrent neural network.

32. The process control system of claim 25, wherein the remedial action is a passive remedial action.

33. The process control system of claim 32, wherein the passive remedial action includes at least one of (i) sounding an alarm, (ii) transmitting a notification, or (iii) displaying an alert.

34. The process control system of claim 25, wherein the remedial action is an active remedial action.

35. The process control system of claim 34, wherein the active remedial action includes at least one of (i) actuating a valve or (ii) causing a stack to release a gas flare, or (iii) performing an action with respect to the plant.

36. One or more data generation devices configured to:
receive reinforcement-learned information;
generate data corresponding to an ongoing industrial control process of a process control system; and
process the generated data using the received reinforcement-learned information.

37. The one or more data generation devices of claim 36, wherein each of the data generation devices is at least one of:
a sensor,
a valve,
a transmitter,
a positioner,
a standard 4-20 mA device,
a field device,
a HART® device,
a Foundation® Fieldbus device,
a Profibus device,
a DeviceNet device,
a ControlNet device; or
a Modbus device.

38. The one or more data generation devices of claim 36, wherein the devices are further configured to:
generate the data corresponding to the ongoing industrial control process of the process control system in response to receiving an activation instruction from a remote anomaly/fault detection application.

39. The one or more data generation devices of claim 36, wherein the received reinforcement-learned information includes a metrics-reward and a Q-table.

40. The one or more data generation devices of claim 36, wherein the reinforcement-learned information includes a function approximation output of a trained artificial neural network.

41. The one or more data generate devices of claim 40, wherein the trained artificial neural network is a recurrent neural network.

42. The one or more data generation devices of claim 39 or 40, wherein the devices are further configured to:
compute a set of metrics corresponding to the ongoing industrial process;
determine, by cross-referencing the set of metrics with the reinforcement learned information, an anomaly/fault action value and a normal action value corresponding to the set of metrics; and
cause, based on the anomaly/fault action value, a remedial action to occur.

43. The one or more data generation devices of claim 42, wherein the remedial action is a passive remedial action.

44. The one or more data generation devices of claim 43, wherein the passive remedial action includes at least one of (i) sounding an alarm, (ii) transmitting a notification or (iii) displaying an alert.

45. The one or more data generation devices of claim 44, wherein the remedial action is an active remedial action.

46. The one or more data generation devices of claim 45, wherein the active remedial action includes at least one of (i) actuating a valve or (ii) causing a stack to release a gas flare, or (iii) performing an action with respect to the plant.

47. The one or more data generation devices of claim 42, wherein the remedial action includes causing at least one of the one or more data generation devices to stop generating the data corresponding to the ongoing industrial control process of a process control system.

48. The one or more data generation devices of claim 36, further configured to:
transmit the generated data to one or both of (i) another data generation device, and (iii) a remote anomaly/fault detection device.

49. The one or more data generation devices of claim 48, further configured to:
receive, in response to the transmitting, updated reinforcement-learned information.
